(19) United States
(12) Patent Application Publication
(10) Pub. No.: US 2011/0134810 A1
(43) Pub. Date: Jun. 9, 2011

(54) MODULE FOR USE IN MOBILE COMMUNICATION TERMINAL AND MOBILE COMMUNICATION TERMINAL APPLYING THE SAME THEREIN

(75) Inventors: Akio Yamamoto, Hiratsuka (JP); Hitoshi Akiyama, Yokohama (JP); Takashi Shiba, Yokosuka (JP); Osamu Hikino, Yokohama (JP)

(73) Assignee: Hitachi Media Electronics Co., Ltd.

(21) Appl. No.: 12/961,771

(22) Filed: Dec. 7, 2010

(30) Foreign Application Priority Data
Dec. 7, 2009 (JP) 2009-277142

(51) Int. Cl. H04B 7/005

(52) U.S. Cl. 370/278

(57) ABSTRACT

For providing a module for use of a mobile communication terminal, being small in sizes and high in reliability, and enabling with plural numbers of bands, and also a mobile communication terminal with using the same therein, canceling is conducted on transmission signal and/or noises of reception band on reception side with using a feed forward technology, for maintaining a degree of suppression of the transmission signal and/or the noises of reception band on the reception side. In this case, for achieving the cancellation of wide band signals from the transmission signal to the reception band, a delay adjusting function is used, in addition to gain and phase adjusting functions. Also, for conducting stable canceling of jamming signals, controls are conducted on the gain, the phase and the delay of a loop with using a reception SN and/or a CQI signal, etc.

Further, for achieving low power consumption, a feed forward loop can be made ON/OFF depending on a level of the transmission signal.

This application relates to and claims priority from Japanese Patent Application No. 2009-277142 filed on Dec. 7, 2009, the entire disclosure of which is incorporated herein by reference.

### BACKGROUND OF THE INVENTION

The present invention relates to a module for use in a mobile communication terminal and a mobile communication terminal applying the same therein. And, in particular, it relates to the module for use in a mobile communication terminal, being compatible with a wireless communication system, such as, a WCDMA method or a LTE method, etc., for example, and the mobile communication terminal applying the same therein.

For a mobile phone, various studies are made on new methods, such as, the LTE method, etc., other than the WCDMA method, which was already put in a practical use thereof. With the WCDMA method and the LTE method, because of simultaneous operation of transmission and reception, they operate in different bands of frequencies, when transmitting and when receiving, for example. In those methods, a DPX (Duplexer) filter is used for separating the transmission band and the reception band.

As a technology for improving the performances of the DPX filter, there is already known that of applying a feed forward technology therein, as described in the following Non-Patent Document 1. In that Non-Patent Document 1 is disclosed a method relating to suppression of reception band noises on the transmission side, in which the feed forward technology is applied therein. For canceling the reception band noises of a narrow band, 869-894 MHz, corresponding to “Band 5” of the WCDMA method, a feed forward loop is constructed with a notch filter and a gain & phase adjusting functions.

### <Prior Art Documents>

### <Non-Patent Documents>

[Non-Patent Document 1] IEEE Transaction on Microwave Theory and Techniques, Vol. 53, No. 1, January 2005 “Adaptive Duplexer Implemented Using Single-Path and Multipath Feedforward Techniques With BST Phase Shifter”.

### BRIEF SUMMARY OF THE INVENTION

In the Non-Patent Document 1 mentioned above, because of an object to cancel only the reception band noises of the narrow band, no particular consideration is paid, in relation to a delay on a feed forward path. Also, no particular consideration is paid upon, also about a power consumption of the feed forward loop.

With the WCDMA method and the LTE method, “Band 1” to “Band 17” (3GPP V8.2.0, a frequency-divisionmultiplex system) is defined, and the number of the bands is in a direction of increasing, further, in the future. For the purpose of dealing with those multi-bands, it is effective to make a frontend portion small in sizes thereof, by bringing the DPX to be tunable.

However, if constructing the DPX with a variable filter, because a degree of suppression of a high-level transmission signal on the transmitter side and/or a degree of suppression of reception band noises on the transmitter side are/is lowered down, it comes up to be a problem that noises leaking from a transmitting system to a receiving system affect ill influences upon the receiving characteristics of a mobile communication terminal. Further, in such case, it is also a problem to suppress an increase of the power consumption down to the minimum.

An object, according to the present invention, is to provide a module for use in a mobile communication terminal, being small in sizes and high in reliability and further operable with plural numbers of bands, in particular, in the module for the mobile communication terminal of conducting the simultaneous operation of transmission and reception, with using different frequency bands when transmitting and when receiving, and also a mobile communication terminal applying the same therein. Further other object of the present invention is to suppress an increase of the power consumption down to the minimum, in such case.

For dissolving the problems mentioned above, according to the present invention, there is applied the structure as described in the pending claims, as an example. In more details, for example, there is provided a module for use in a mobile communication terminal, for executing transmission/reception simultaneous operation, with using different frequency bands as transmission frequency and reception frequency, comprising: a filter having variable characteristics, which is configured to separate a transmission signal and a reception signal, and configured to pass frequency signals in plural numbers of bands therethrough, selectively; and a jamming signal cancel portion, which is configured to cancel the transmission signal and noises of reception band on the transmission side by a predetermined amount thereof.

According to the present invention, it is possible to provide a module for use of a mobile communication terminal, being small in sizes and high in reliability, and enabling with plural numbers of bands, and also a mobile communication terminal with using the same therein.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an example of the structures of a module for use in a mobile communication terminal, according to a first embodiment of the present invention;

FIG. 2 is a block diagram for showing the details of a DPX applied within the first embodiment;

FIG. 3 is view for showing frequency band to be used in the WCDMA and LTE methods;

FIGS. 4A and 4B are views for showing d characteristics of a fixed frequency DPX and a variable frequency DPX;

FIG. 5 is a view for showing each block and a degree of suppression of disturbance or jamming waves, in the first embodiment;

FIGS. 6A and 6B are views for showing performances necessary in a canceller in the first embodiment;

FIGS. 7A and 7B are view for showing waveforms of a control method for achieving low power consumption;

FIG. 8 is a sequential view (or flowchart) of a transmission/reception method with using a jamming canceller and a distortion canceller therein;

FIG. 9 is a block diagram for showing an example of the structures of a module for a mobile communication terminal, according to a second embodiment of the present invention;

FIG. 10 is a view for showing an example of characteristics of a circulator according to the second embodiment;

FIG. 11 is a block diagram for showing an example of the structures of a module for use in a mobile communication terminal, according to a third embodiment of the present invention; and

FIGS. 12A and 12B are a block diagram, etc., for showing an example of the structures of the mobile communication terminal, according to the third embodiment.

### DETAILED DESCRIPTION OF THE PREFERRED EMBODIMENTS

Hereinafter, embodiments according to the present invention will be fully explained by referring to the attached drawings.

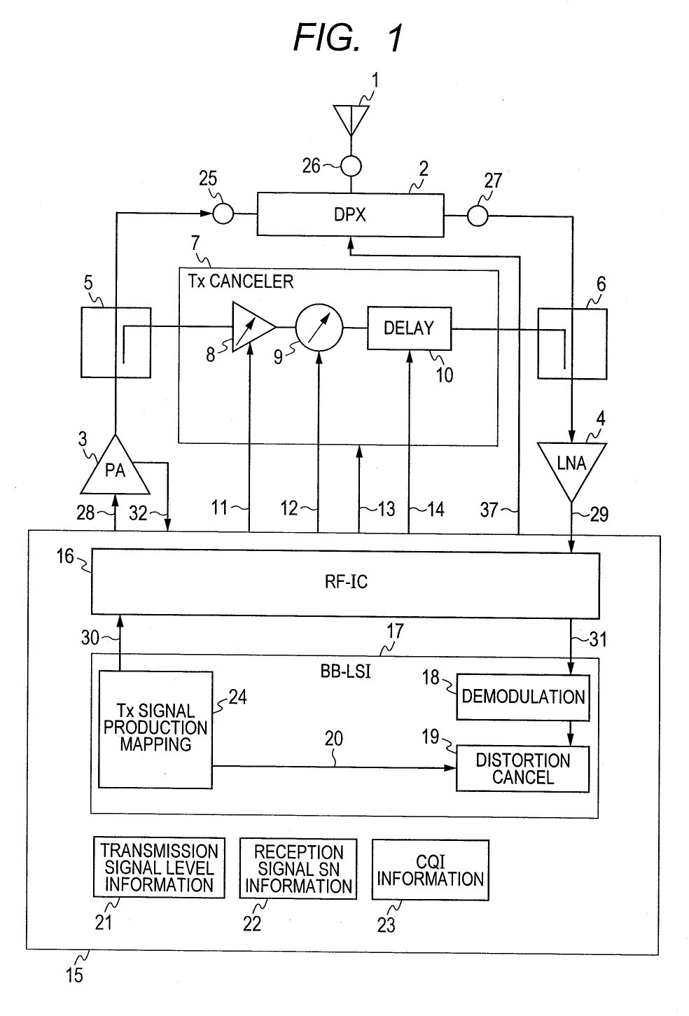

FIG. 1 is a block diagram for showing an example of the structures of a module for use in a mobile communication terminal, according to a first embodiment. The structures of the present embodiment are especially for a module for use in a mobile communication terminal of, such as, the WCDMA method, etc., for example; however, of course, it should not be limited to this if it is a module for use in a mobile communication terminal of conducting the simultaneous operation of transmission and reception, with using different frequency bands when transmitting and when receiving.

First of all, explanation will be given on a flow of signal. A transmission signal 28 to be outputted from a modem (a modulator/demodulator) block 15 is amplified within a PA (Power Amplifier) 3, to be inputted to a transmission input terminal 25 of a DPX (Duplexer) 2, and it is outputted from an antenna-side terminal 26 of the DPX 2, extracting a transmission signal band through a filtering process, and it is outputted as a transmission signal of a terminal, from an antenna 1.

On the other hand, the reception signal received by the antenna 1 is inputted from the antenna-side terminal 26 of the DPX 2, and is outputted from a receiving output terminal 27 of the DPX 2, extracting a reception signal band therefrom through a filtering process, and then it is inputted to the modulated/demodulated signal processor block 15 through a LNA (Low Noise Amplifier) 4 as a reception signal 29. Within a RF signal processor block 16 of the modulated/demodulated signal processor block 15, the reception signal 29 is converted into a reception base-band signal 31, to be inputted into a base-band signal processor block 17, and at the same time, a transmission base-band signal 30 is converted on the frequency thereof, into a transmission signal 28. Within the base-band signal processor block 17 of the modulated/demodulated signal processor block 15, a transmission base-band signal 30 is produced in a Tx signal producing/mapping block 24, while a reception base-band signal 31 is demodulated in a demodulator block 18. Within the modulated/demodulated signal processor block 15 are stored transmission signal level information 21, reception signal SN information 22, and CQI (Channel Quality Information) information 23. The transmission signal level information 21 is produced from an output detection level 32 of PA 3 and/or transmission signal control information from a base station, which is included in the reception signal, etc. The reception signal SN information 22 and the CQI information 23 are produced from an error rate when demodulating the reception signal within the demodulatorblock 18, etc. The DPX2 is frequencyvariable for enabling to transmit/receive plural numbers of Bands, and controls the frequency upon basis of a control signal 37.

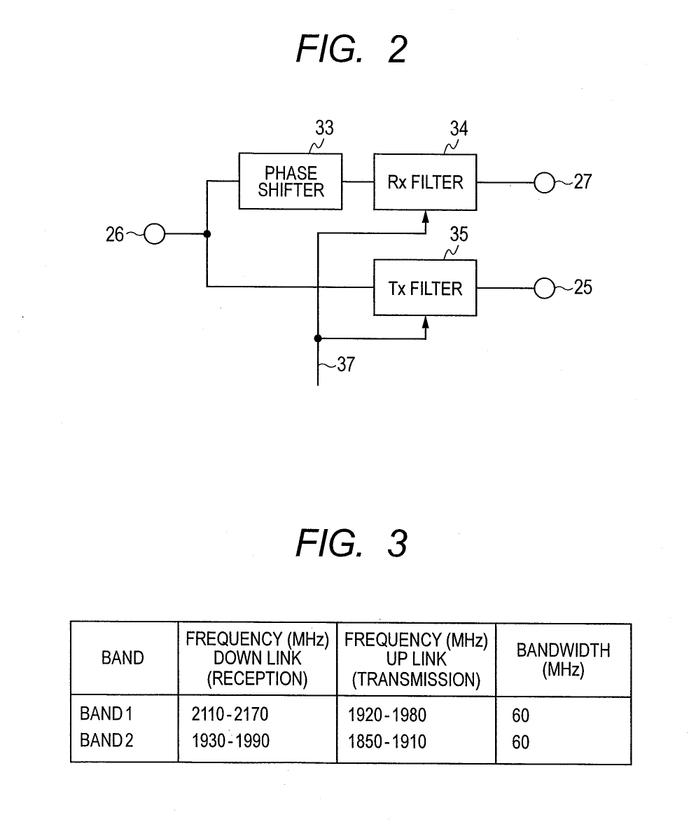

The DPX 2 is constructed with, as is shown in FIG. 2, a phase shifter 33, an Rx filter 34 for passing only a signal of reception band therethrough, selectively, and a Tx filter 35 for passing a signal of transmission band therethrough, selectively.

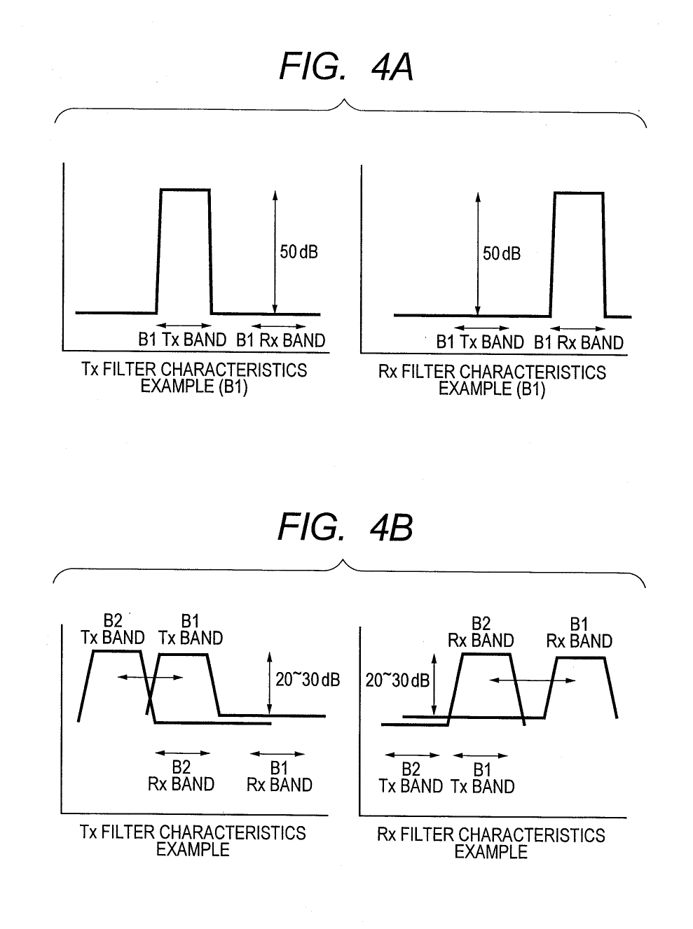

In general, for the purpose of maintaining sufficient selectivity, the Rx filter 34 and the Tx filter 35 are constructed with SAW filters, etc., and are used as fixed frequency filters. FIG. 4A shows the characteristics of the fixed frequency filter. In case where the fixed frequency filter is applied, for example, as the DPX for passing the signal of Band 1 shown in FIG. 3 therethrough, as is shown in FIG. 4A, there can be obtained a degree of suppression of about 50 dB in the Rx band as the performances of the Tx filter 35, and a degree of suppression of about 50 dB in the Tx band as the performances of the Rx filter 34.

In the present embodiment, a frequency-variable filter is used as the DPX. For example, there is used a filter having such variable characteristics that the frequency signals of the Band 1 and the Band 2, having the characteristics shown in FIG. 3, can pass therethrough, selectively. FIG. 4B shows an example of the characteristics of the variable frequency filter. When the filter is made variable in the characteristics thereof, Q of the filter is deteriorated comparing to that of the fixed filter mentioned above, and it can be seen that, as is shown in FIG. 4B, the degree of suppression of noises of Rx band comes to around 20-30 dB, as the performances of the Tx filter 35, and the degree of suppression of noises of Tx band comes to around 20-30 dB, as the performances of the Rx filter 34. In this manner, when applying the variable filters, since the degree of suppression is not enough comparing to that of the fixed filter, there is a problem of increasing up a risk to be high, that the transmission signal on the transmission side and/or the noises of the reception band of the transmission side leak into the receiver side.

Then, according to the present embodiment, as is shown in FIG. 1, for example, by adding two (2) sets of new circuit constructions, those will be compensated. Thus, a jamming wave canceller block 7 within a front-end block and a distortion canceller block 19 within a base band portion.

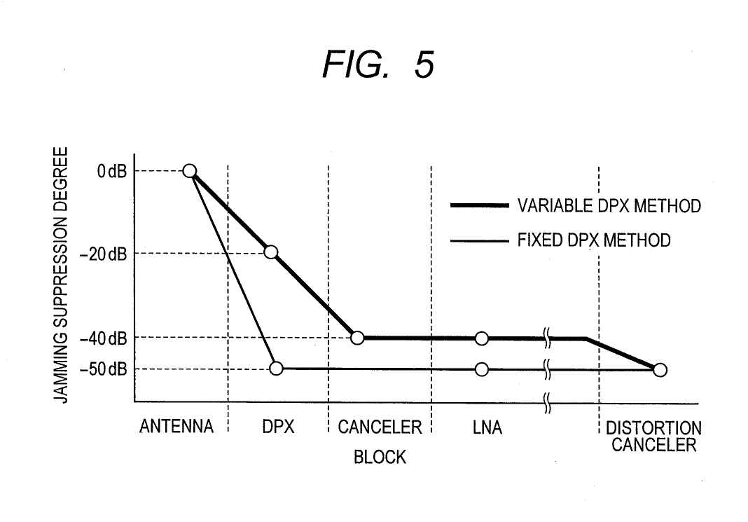

FIG. 5 shows a graph of describing an example of suppression level of jamming waves in each block. With the DPX method of using the fixed frequency therein, compression of jamming of about 50 dB is conducted in the DPX, and an input is made to LNA with jamming wave level of −50 dB. With the variable DPX method of using the variable frequency filter therein, the suppression degree by the variable DPX is 20 dB, for example. Then, it is further suppressed by the jamming wave canceller, for example, 20 dB, and then it is inputted to the LNA with the jamming wave level of −40 dB, for example. With the variable DPX method, since the jamming waves, higher 10 dB comparing to that of the fixed frequency method, are inputted, then distortion occurs in the LNA 4 and the RF signal processor block 16. Then, the distortion interruption generated is cancelled by means of the distortion canceller.

A jamming wave canceller within the front end portion is constructed with a feed-forward loop of a coupler 5 for distributing the transmission signal of an output of the PA 3, thereby inputting to the jamming wave canceller 7, the jamming wave canceller 7, and a coupler 6 for composing an output of the jamming wave canceller 7. The jamming waves to be cancelled by this feed-forward loop are transmission signals, leaking from the transmitting system through the DPX 2, and also noises of the reception signal band leaking from the transmitting system through the DPX 2 into the receiving system.

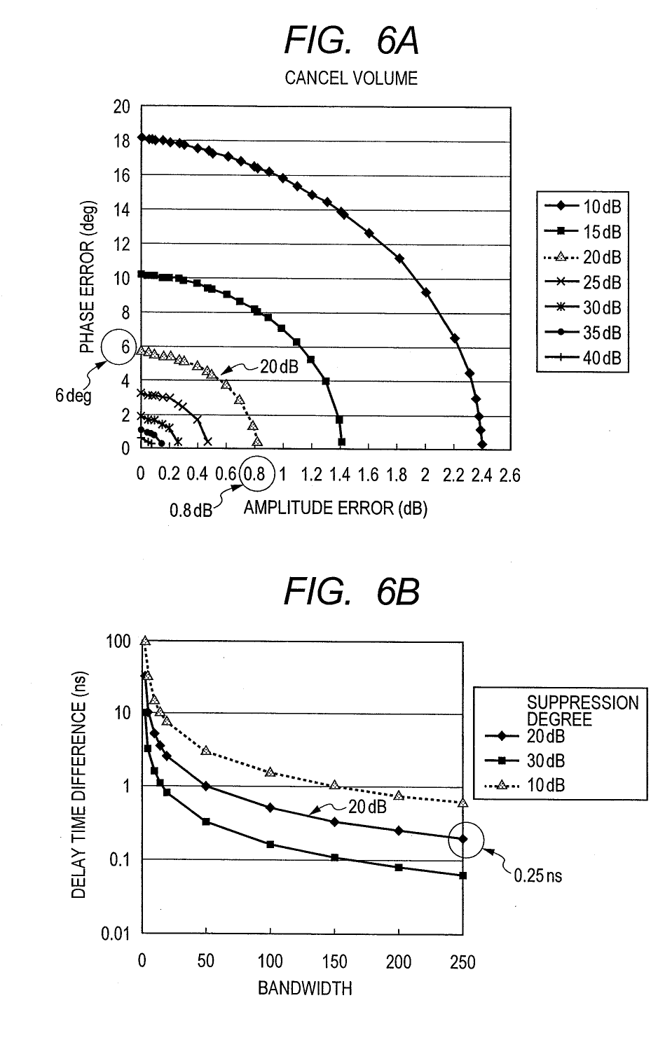

The jamming wave canceller 7 is constructed with an amplitude adjuster 8, a phase adjuster 9 and a delay adjuster 10. With those adjusting mechanisms, signals of reverse phases are produced, with equal amplitudes to the transmission signal leaking through the DPX 2 and the noises of the reception signal band, and are composed within the composer 6; thereby canceling the jamming waves. Result of calculation about to what extent of the performances is required on the amplitude, the phase and the delay error of the jamming wave canceller 7, are shown in FIGS. 6A and 6B. For example, when suppressing the transmission signal and the noises of the reception signal band by 20 dB, it is necessary to suppress an error between a signal leaking from the DPX 2 and a signal of the feed-forward loop to be equal or lower than 0.8 dB on the amplitude, and 6 degree in the phase thereof. Regarding a delay amount, when assuming the Band 1, it is a wide band from the transmission signal band to the reception signal band, i.e., 1,920-2,170 MHz, covering over about 250 MHz, as is shown in FIG. 3, and it is necessary for the delay amount to cancel the jamming or noise of bandwidth of this 250 MHz, to be equal or less than 0.25 ns.

In this manner, because of necessity of an error of high accuracy, each adjusting mechanism is that of a method of managing the error under control from the modulated/demodulated signal processor block 15. In more details, adjustments are made on the amplitude adjuster 8 by a control signal 11, on the phase adjuster 9 by a control signal 12, and on the delay adjuster 10 by a control signal 14, respectively, so that SN of the reception signal detected by the modulated/demodulated signal processor block 15, for example, comes up to the maximum.

On the other hand, the time when the jamming canceller 7 is necessary is only when the level of the transmission signal is high. For this reason, for achieving a low power consumption, such ON/OFF control is made on the jamming wave canceller 7 that it turns ON, by a control signal 13, only when the level of the transmission signal is high.

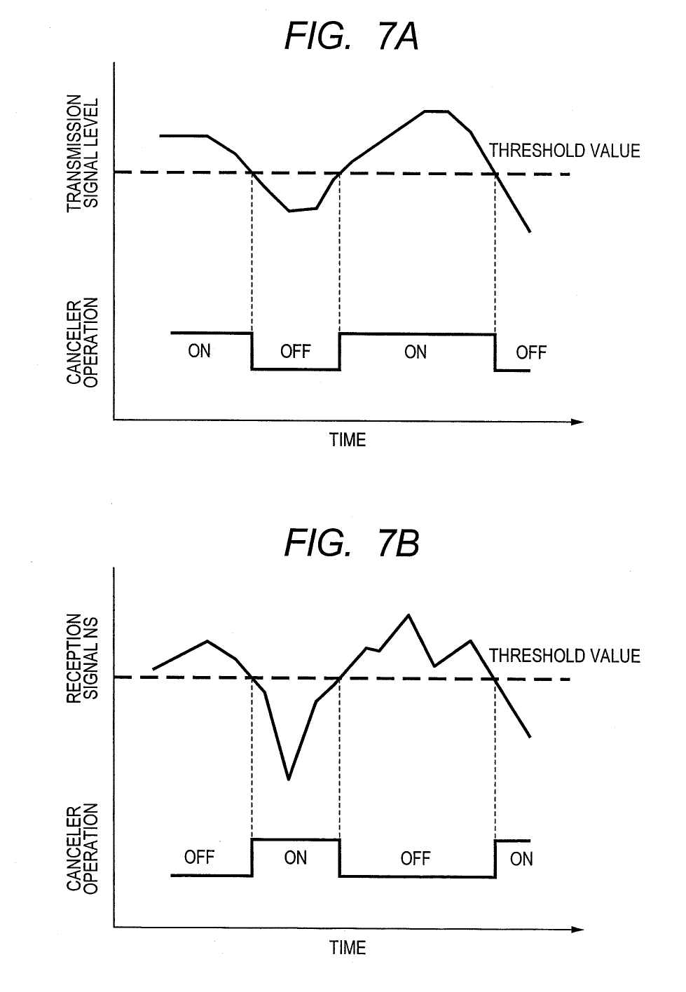

FIGS. 7A and 7B are views for showing waveforms of ON/OFF control of the jamming wave canceller 7. FIG. 7A shows the control when using the level of the transmission signal as a threshold value, wherein the jamming wave canceller 7 is turned ON when the level of the transmission signal is equal or higher than a predetermined value, while it is turned OFF other than that. FIG. 7B shows the control when using S/N of the reception signal as a threshold value, wherein the jamming wave canceller 7 is turned ON when the S/N of the reception signal is equal or lower than a predetermined value, while it is turned OFF other than that.

The distortion canceller block 19 within the base band portion is a block for canceling a 2^{nd} order distortion component, which is generated within the LNA 4 and/or the RF signal processor block 16 when the transmission signal leaking from the DPX 2 is high. The transmission signal, as a cause of reason of the distortion, is the signal, which is produced within the base-band signal processor block 17, and it is already known, and since the signal 20 is equal to the transmission signal 30, it is possible to cancel the distortion component, i.e., producing the 2^{nd} order distortion component by squaring the signal 20 and composing it to the distortion component included in the reception signal in the reverse phase thereof within the distortion canceller block 19. When composing, an adjustment of the distortion canceller block 19 is made, in such a manner that the S/N of the reception signal detected within the modulated/demodulated signal processor block 15 comes to the maximum, for example.

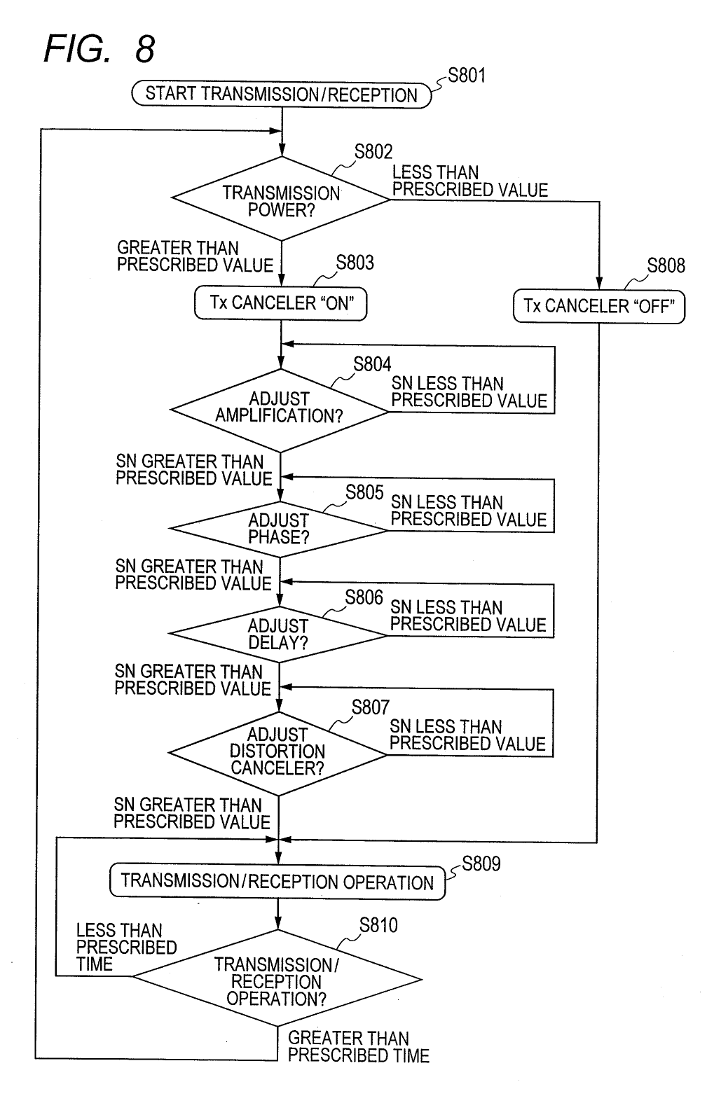

FIG. 8 is a flowchart for showing a series flow of cancel operation mentioned above. After starting the transmission/reception (step 801), determination is made on transmission power (step 802), and when the transmission power is equal or greater than a predetermined value (for example, being equal or greater than +15 dBm when transmitting the Band 1), the jamming wave canceller 7 is turned ON (step 803), while the jamming wave canceller 7 is turned OFF (step 808) when it is less than the predetermined value (for example, being equal or greater than +15 dBm when transmitting the Band 1). When turning the jamming wave canceller 7 ON, the amplitude adjustment, the phase adjustment and the delay adjustment are conducted by the amplitude adjuster 8, the phase adjuster 9 and the delay adjuster 10, respectively and dependently; i.e., the adjustments are made in such a manner that the SN of the reception signal comes to be equal or greater than a predetermined value (steps 804-806). Also, similarly, in adjustment within the distortion canceller block 19, the adjustment is made in such a manner that the SN of the reception signal come to be equal or greater than a predetermined value (step 807). Thereafter, when the transmission/reception time exceeds a prescribed value, determination of the transmission power is made, again (steps 810 and 802). As the prescribed value of the transmission/reception time can be considered a one (1) slot (about 667 us) or a one (1) frame (about 15 ms) of the WCDMA method, etc., for example.

As was mentioned above, according to the present embodiment, for the purpose of maintaining the suppression degree of the transmission signal and the noises of the reception band on the transmission side, canceling of the transmission signal and/or the noises of reception band on the transmission side is made with using a feed forward technology. In this instance, for achieving cancellation of the signals of wide band, from the transmission signal to the reception band, within the feed forward loop is applied the delay adjusting function, in addition to the gain and the phase adjusting functions. And also, for achieving a stable cancellation of the jamming signals, control is made on the gain, the phase and the delay of the loop with using the reception SN and CQI (Channel Quality Information), etc. Further, for achieving the low power consumption, the feed forward loop can be turned ON/OFF.

Also, according to the present embodiment, small-sizing of the terminal can be obtained by making the DPX 2 operable corresponding to variable frequencies, and also the shortage of the suppression degree of the jamming waves is filled up by the jamming wave canceller and the distortion canceller, therefore there can be obtained an effect also on the low power consumption by turning ON/OFF the jamming wave canceller depending on the level of the jamming waves.

With the embodiment 1 shown in FIG. 1, although the DPX 2 adopts the variable filter construction; however, the similar effect can be obtained if applying the DPX of the fixed frequency therein. Also, the jamming wave canceller 7 and the distortion canceller 9 may be applied, at the same time, or may be applied either one of them, in the method thereof.

### Embodiment 2

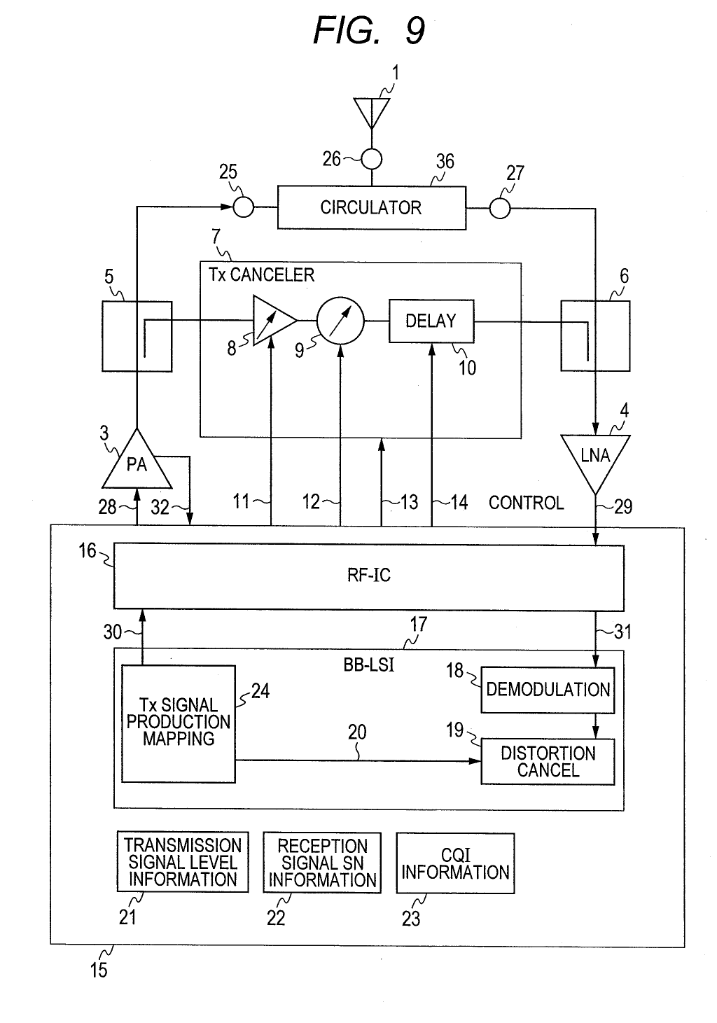

FIG. 9 is a block diagram for showing an example of the structure of a module for use in the mobile communication terminal, according to a second embodiment. Herein, in the place of the variable DPX 2 according to the embodiment 1 is used a circulator 36. Since other components than that are same to those of the embodiment 1, explanation thereof will be omitted. The circulator is a device for obtaining isolation between terminals with using a physical phenomenon, such as, a Faraday rotation, etc., for example, and wherein, signals can pass through between terminals 25 and 26 and terminals 26 and 27 of the circulator 36, without attenuation thereof, and therefore, it is possible to make the signal leakage small, from the transmission system to the reception system, covering over a relatively wide band, by bringing the isolation between the terminals 25 and 27.

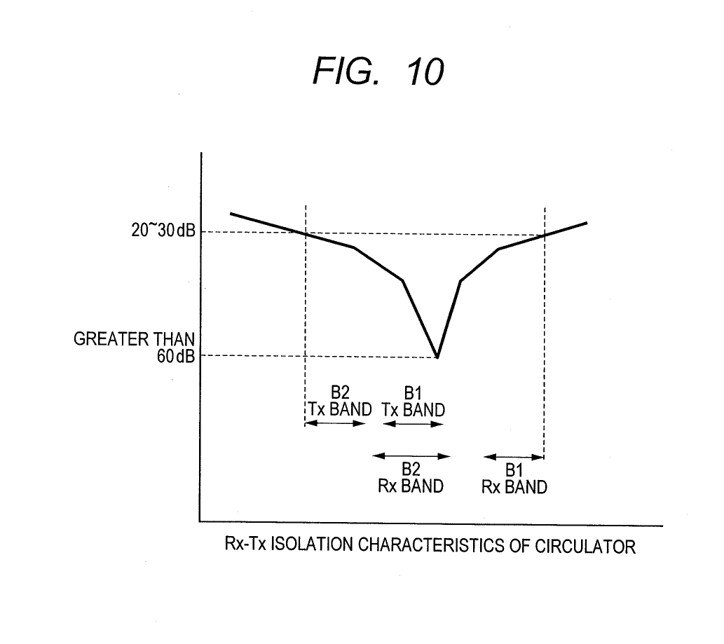

FIG. 10 is a view for showing the isolation characteristics between the transmission system and the reception system of the circulator. Although high isolation of about 60 dB can be obtained at a peak, but only isolation of about 20-30 dB, for example, can be obtained at an end of the band of the transmission signal of Band 2 and/or at an end of the band of the reception signal of Band 1. Accordingly, similar to that of the embodiment 1 shown in FIG. 1, the jamming signal is suppressed with using the jamming wave canceller 7 and/or the distortion canceller block 19.

With the present embodiment, other than the effect similar to that of the embodiment 1 shown in FIG. 1, it can be constructed to be small, comparing to the variable DPX, with applying the circulator therein.

Although explanation of the details thereof will be omitted, but the variable DPX 2 can be achieved by exchanging “C” of a multi-stage filter with using a variable capacity diode, etc. Also, the amplitude adjuster 8 is a gain control amplifier, which is usually applied, and it can change current of the amplifier or adjust the amplitude by switching over a load resistance. The phase adjuster 9 can make the phase adjustment by changing “C” of a LC ladder type circuit, which is usually applied, by a variable capacity diode, etc. Also, the delay adjuster 10 can be easily achieved by adjusting the delay with using a filter having the similar structure to that of the variable DPX, or switching over “L” of the LC ladder type circuit with using a switching diode, etc.

### Embodiment 3

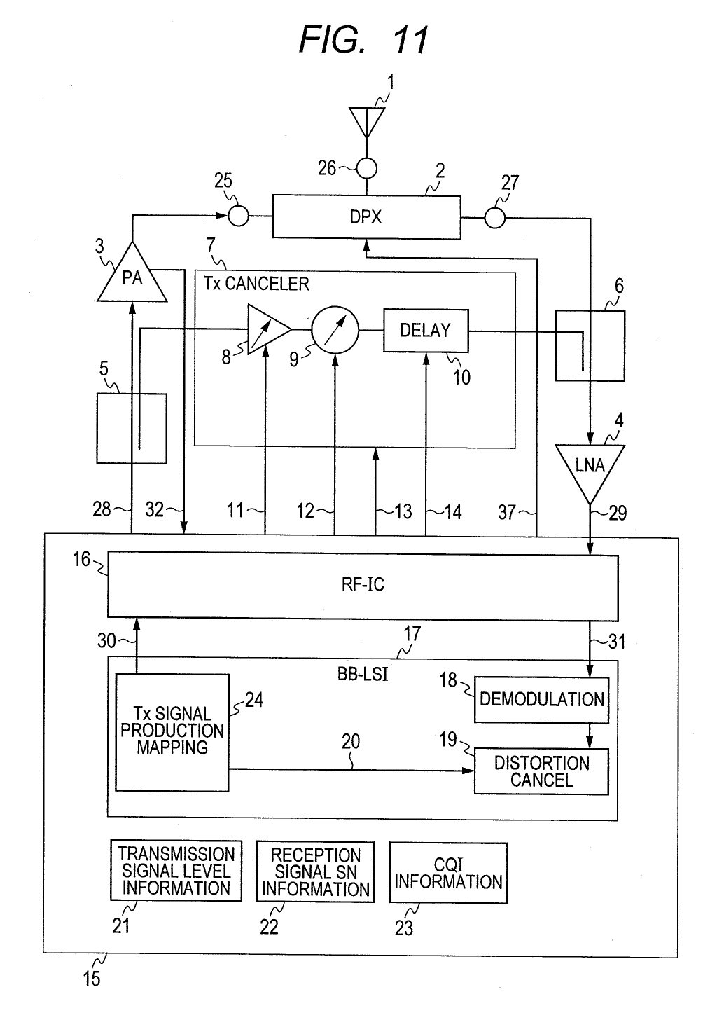

FIG. 11 is a block diagram for showing an example of the structure of a module for use in the mobile communication terminal, according to a third embodiment. In this FIG. 11, a jamming wave cancel within the front-end portion is inputted from the coupler is build up by a feed forward loop, which is constructed with the distributor 5, the jamming wave canceller 7 and a composer 6. The transmission signal 28 to an input of the PA 3, after being distributed within the distributor 5, is inputted to the jamming wave canceller 7. The composer 6 composes an output of the jamming wave canceller 7 and an output of the DPX 2, thereby to input it to the LNA 4. There can be obtained an effect similar to that of the embodiment 1 shown in FIG. 1, i.e., distributing it from the output of the PA 3 and inputting it to the jamming wave canceller 7.

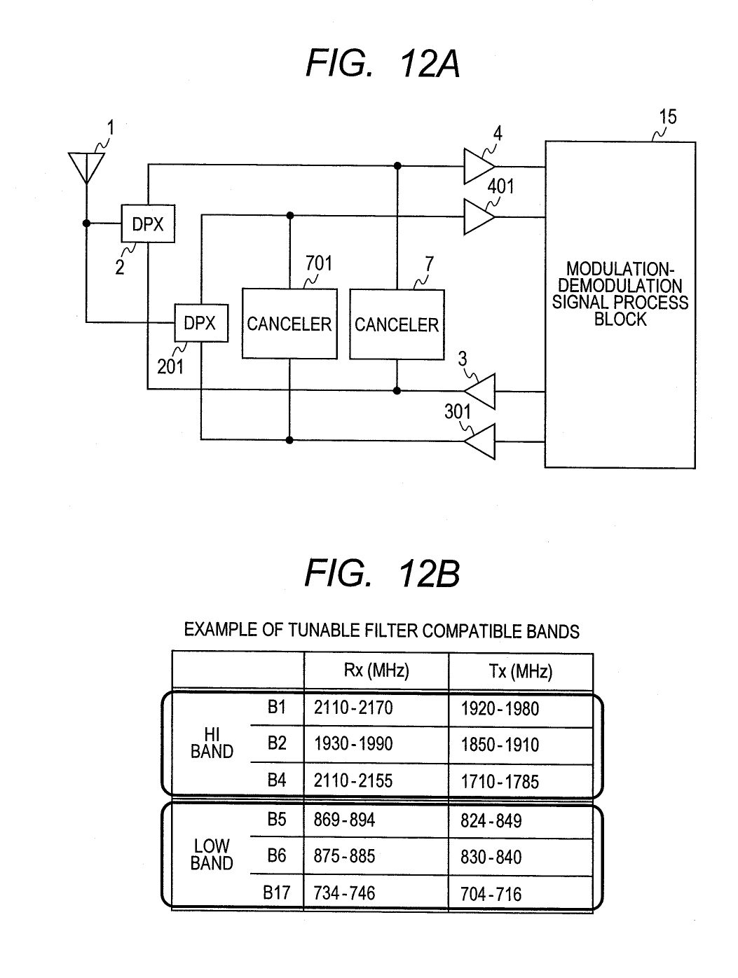

FIG. 12 is a block diagram for showing an example of applying the module according to the present invention into a multi-band enable mobile communication terminal. As an example of the multi-band, when receiving Bands 1, 2, 4, 5, 6 and 17, the terminals are constructed by dividing them into two (2) groups; i.e., the Bands 1, 2 and 4 of 1,700 MHz-2,100 MHz band as a band group 1, and the Bands 5, 6 and 17 of 700 MHz-800 MHz as a band group 1. The terminal is constructedwith the DPX 2 for changing a frequency band of the band group 1, a DPX 201 for changing a frequency band of the band group 2, the jamming wave canceller 7 for conducting suppression of jamming waves of the frequency band of the band group 1 and noises, a jamming wave canceller 701 for conducting suppression of jamming waves of the frequency band of the band group 2 and noises, LNA 4 and PA 3 for amplifying the transmission wave of the band group 1, and LNA 401 and PA 301 for amplifying the transmission wave of the band group 2.

As was shown in the present embodiment, with conducting the signal processing by dividing into two (2) band groups, it is possible to achieve necessary performances, as is shown in FIG. 4B and FIG. 5, with a relative ease. In the present embodiment, as an example of the multi-band, the Bands 1, 2, 4, 5 and 17 are divided into two (2) sets of groups, in the structures thereof; however, the present invention should not be limited only to this, but it is also possible to deal with a further different Band reception (for example, Band 2, Bands 11-16), or a number of the band groups may be increased up. In this instance, it may be sufficient to add the DPX(s) and the jamming wave canceller(s) depending upon the number of the band groups.

However, the present invention should not be limited to the embodiments mentioned above, but may include various variations thereof. For example, the detailed explanation was given on embodiments mentioned above for easy understanding of the present invention, then the present invention should not be restricted to that having all of the constituent elements explained in the above. Also, a part of the structure of any embodiment can be substituted by the structure of other embodiment, and the structure of other embodiment can be added to the structure of a certain embodiment, etc.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A module for use in a mobile communication terminal, for executing transmission/reception simultaneous operation, with using different frequency bands as transmission frequency and reception frequency, comprising:
a filter having variable characteristics, which is configured to separate a transmission signal and a reception signal, and configured to pass plural numbers of frequency signals therethrough, selectively; and
a jamming signal cancel portion, which is configured to cancel the transmission signal leaking from a transmission side to a reception side and noises of reception band on the transmission side by a predetermined amount thereof.

2. The module for use in a mobile communication terminal, as is described in the claim 1, further comprising
a distortion cancel portion, which is configured to cancel distortion generated due to the transmission signal leaking from the transmission side to the reception side.

3. The module for use in a mobile communication terminal, as is described in the claim 1, wherein
said jamming signal cancel portion comprises a block, which is configured to control an amplitude, a phase and a delay time of a jamming signal, thereby controlling the amplitude, the phase and the delay time of the jamming signal in such that SN of the reception signal comes to optimal.

4. The module for use in a mobile communication terminal, as is described in the claim 1, wherein
said jamming signal cancel portion exchanges ON/OFF of an operation of canceling the transmission signal leaking from the transmission side to the reception side and the noises of reception band on the transmission side by a predetermined amount thereof, depending on a level of a jamming signal or an amplitude of SN of the reception signal.

5. The module for use in a mobile communication terminal, as is described in the claim 1, wherein said filter is a circulator.

6. The module for use in a mobile communication terminal, as is described in the claim 2, wherein said filter is a circulator.

7. The module for use in a mobile communication terminal, as is described in the claim 3, wherein said filter is a circulator.

8. The module for use in a mobile communication terminal, as is described in the claim 4, wherein said filter is a circulator.

9. A mobile communication terminal, comprising:
a module for use in a mobile communication terminal as is described in the claim 1, whereby executing the transmission/reception simultaneous operation, with using the different frequency bands as the transmission frequency and the reception frequency.

10. A mobile communication terminal, comprising:
a module for use in a mobile communication terminal as is described in the claim 2, whereby executing the transmission/reception simultaneous operation, with using the different frequency bands as the transmission frequency and the reception frequency.

11. A mobile communication terminal, comprising:
a module for use in a mobile communication terminal as is described in the claim 3, whereby executing the transmission/reception simultaneous operation, with using the different frequency bands as the transmission frequency and the reception frequency.

12. A mobile communication terminal, comprising:
a module for use in a mobile communication terminal as is described in the claim 4, whereby executing the transmission/reception simultaneous operation, with using the different frequency bands as the transmission frequency and the reception frequency.

13. A mobile communication terminal, comprising:
a module for use in a mobile communication terminal as is described in the claim 5, whereby executing the transmission/reception simultaneous operation, with using the different frequency bands as the transmission frequency and the reception frequency.

14. A mobile communication terminal, comprising:
a module for use in a mobile communication terminal as is described in the claim 6, whereby executing the transmission/reception simultaneous operation, with using the different frequency bands as the transmission frequency and the reception frequency.

15. A mobile communication terminal, comprising:
a module for use in a mobile communication terminal as is described in the claim 7, whereby executing the transmission/reception simultaneous operation, with using the different frequency bands as the transmission frequency and the reception frequency.

16. A mobile communication terminal, comprising:
a module for use in a mobile communication terminal as is described in the claim 8, whereby executing the transmission/reception simultaneous operation, with using the different frequency bands as the transmission frequency and the reception frequency.
